(19) United States
(12) Patent Application Publication
(10) Pub. No.: US 2011/0022619 A1
(43) Pub. Date: Jan. 27, 2011

(54) System For Docketing Court Receipts

(76) Inventors: Kin Yew Lee, Monterey Park, CA (US); Juliano Zucchetto Teixeira, Sherman Oaks, CA (US); Gabriel B. Garza, Reseda, CA (US); Geoffrey Scott Davis, Alamo, CA (US); Chelise Anderson, Chicago, IL (US); Mark Goldin, Los Angeles, CA (US); Joey Y. Perez, Los Angeles, CA (US); Dong Chen Han, Simi Valley, CA (US)

Correspondence Address: Norvell IP LLC, 1776 Ash Street, Northfield, IL, 60093, US

(21) Appl. No.: 12/509,283

(22) Filed: Jul. 24, 2009

(51) Int. Cl. G06F 17/30

(52) U.S. Cl. 707/769; 707/812; 707/E17.014

(57) ABSTRACT

A system is described for docketing court receipts. The system may receive court receipts from a court and scan the court receipts for docket information that may be used to create docket entries and events. The system may associate the court receipts with preexisting case dockets. The system may retrieve and store case documents referenced in the court receipts from an online server. The system may apply applicable court rules to information retrieved from the court receipts to generate events. The docket entries and events created by the system may be used to generate and/or update case dockets efficiently and accurately.

### BACKGROUND

Maintaining an accurate and up-to-date docket is a critical aspect to the practice of law. The docket includes the official schedule of a legal proceeding or other time-sensitive matter, collectively referred to as a proceeding or case, before a court of law, tribunal or other administrative body, collectively referred to as a court. The docket maintains identifiable information related to the case, such as the parties, case number, court name, judge name, listing of attorneys registered in the case, etc. The docket also includes docket entries, which refer to a chronological list of documents and entries filed in a case, and events, which refer to certain dates in which one or more actions must occur in the case, e.g., deadline for answering a complaint, deadline for responding to discovery requests, etc. The docket may also include reminders to the events, which may be set at user definable time periods, e.g., one month, two weeks, one week, three days, one day, etc. Attorneys at law firms and corporations may refer to and rely upon the docket to manage workloads, plan for certain events, and otherwise prepare for and litigate the case. Many law firms and corporations handling or involved in such proceedings utilize case management software to facilitate the maintenance and accuracy of their dockets. Examples of such case management software include eDockets™, CompuLaw®, ProLaw®, and Time Matters®.

Many courts also utilize case management software applications and electronic filing systems to increase efficiency and accuracy in their docket management. An example used by most United States federal courts is Case Management/Electronic Case Files (“CM/ECF”). CM/ECF is a web-based application operated by the individual federal courts that allows these courts to maintain case documents, e.g., pleadings, motions, petitions, etc., in electronic format, and permits registered attorneys to electronically file case documents over the Internet, as opposed to submitting documents in paper form via in-person filing with the clerk's office. In fact, in some courts, parties are required to utilize CM/ECF for all filings with the court. In response to an electronic filing, or other activity in a case, e.g., court order, notice, minute entry, etc., the court may send a Notice of Electronic Filing, also referred to as a court receipt, by electronic mail (“email”) to the registered attorneys in the case. Upon receiving the court receipt, the attorneys or other personnel employed at or engaged by the participating law firms and/or corporations, e.g., docket clerks, must manually transfer the information contained therein to their case management software in order to update their dockets accordingly. For example, the docket clerks may print off the court receipt and manually re-enter the information, or copy and paste the information into their case management software.

Moreover, United States federal courts utilize a document server to make case documents available to the parties and public, which is called Public Access to Court Electronic Records (“PACER”). State courts and other judiciary bodies may utilize a similar system. In the example of PACER, when law firms and/or corporations receive a court receipt, the receipt may refer to one or more case documents that were filed by one or more of the parties or by the court. To retrieve the case documents, the docket clerks must access PACER and manually download the case documents to a local database or server to be accessible by the attorneys participating in the case.

The above described manual processes of transferring information from the court receipt to the case management software and downloading the case documents from an external server must be performed for each court receipt received. It is critical that these manual processes be performed in a timely fashion in order to maintain accurate and up-to-date dockets. If a law firm or corporation is handling a number of cases simultaneously, the number of court receipts received may increase quickly. Moreover, in hotly contested cases, the parties may engage in a series of filings, thereby increasing the number of court receipts for an individual case. Therefore, it may be time consuming for docket clerks to manually process and docket each of these receipts. Moreover, the repetitious and monotonous nature of the work, and considering the amount of human involvement, may result in typographical errors, filing a receipt under the incorrect case, or other errors in the docket, which could have a detrimental impact on the outcome of the litigation for the law firm and the client. This could result in a missed deadline, jeopardizing the rights of the party in the litigation and resulting in possible court sanctions. For law firms, these errors could result in a malpractice claim. Moreover, as the case loads increase, law firms and corporations are forced to increase docket staff in order to timely process each of the court receipts, which increases the transactional costs for processing court receipts.

### SUMMARY

By way of background, the embodiments described below include a system for docketing court receipts. The embodiments relate to receiving court receipts from a court, associating the court receipts with a case, retrieving case documents referenced by the court receipts, and creating docket entries based on information retrieved from the court receipts. The embodiments further relate to applying court rules to information retrieved from the court receipts to generate events. The embodiments further relate to outputting docket entries and events based on the court receipts.

In a first aspect, a method is disclosed for docketing a court receipt, including: receiving a court receipt from a court, associating the court receipt with a case, retrieving docket information from the court receipt, and creating a docket entry for the case based on the docket information.

In a second aspect, a system is disclosed for docketing a court receipt, including: a mail server operable to receive a plurality of court receipts from one or more courts to be stored on a database, a case assignment processor coupled with the database and operable to assign the plurality of court receipts to a case, and a docket processor coupled with the database and operable to create docket entries based on the information retrieved from the court receipts and the case assignment.

In a third aspect, a system is disclosed for docketing a court receipt, including: assigning means for assigning a court receipt received from a court to a case docket, retrieving means for retrieving information from the court receipt, and generating means for generating a docket entry as a function of the assigning means and retrieving means.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of an exemplary system for docketing court receipts.

FIG. 2 shows an exemplary court receipt received from a court.

FIG. 3 is an exemplary display generated from data obtained by the system for docketing court receipts.

FIG. 4 is an exemplary docket dialog box from the display shown in FIG. 3.

FIG. 5 is an exemplary docket dialog box from the display shown in FIG. 3.

FIG. 6 is an exemplary docket dialog box from the display shown in FIG. 3.

FIG. 7 is an exemplary event dialog box from the display shown in FIG. 3.

FIG. 8 is a flow chart of one example of docketing a court receipt.

FIG. 9 is a flow chart of one example of generating a docket event.

### DETAILED DESCRIPTION

The disclosed embodiments provide a system for docketing court receipts. The system may receive court receipts from one or more courts and may retrieve information from the receipts that may be used to generate docket entries and events. The system may associate a court receipt with an existing case based on the case number or some other identifying feature, such as court name, case name, parties, listed attorneys, etc., that may be retrieved from the court receipt. The system may also allow a user to create a new case, or manually assign a court receipt to an existing case, which information may be used by the system in assigning subsequent court receipts. The system may retrieve and make available case documents referenced in the court receipts. The system may create docket entries based on information retrieved from the court receipts. The system may also apply court rules to information retrieved from the court receipts to generate events. The system may output the docket entries and events to be used in generating and/or updating a case docket.

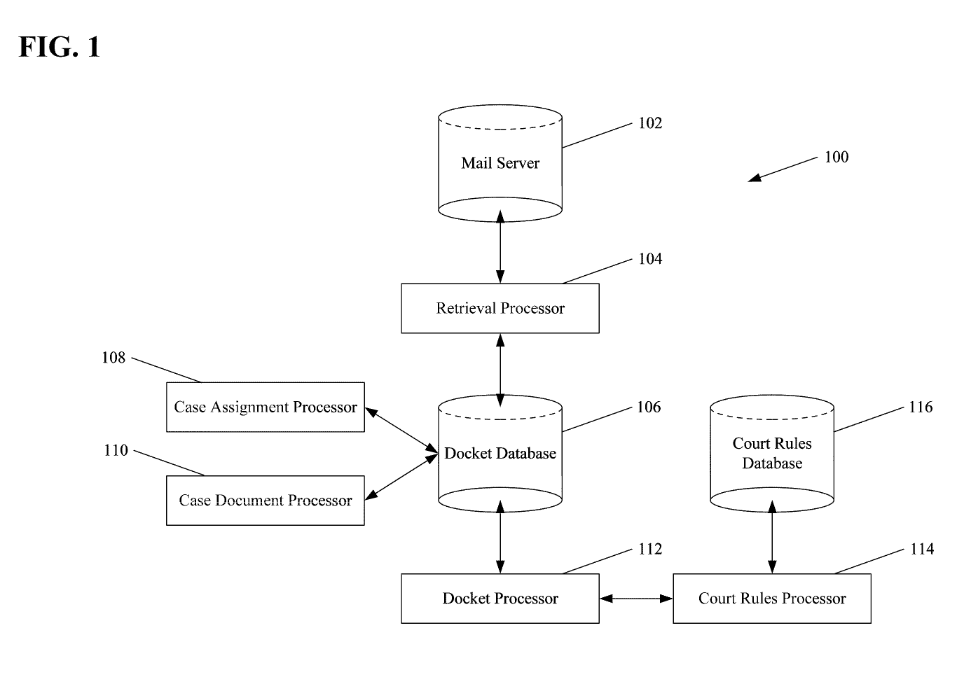

A system 100 for docketing court receipts according to one embodiment is shown in FIG. 1. As shown, the system 100 includes a mail server 102, a retrieval processor 104 coupled with the mail server 102, a docket database 106 coupled with the retrieval processor 104, and a case assignment processor 108, a case document processor 110, and a docket processor 112 all coupled with the docket database 106, a court rules processor 114 coupled with the docket processor 112, and a court rules database 116 coupled with the court rules processor 114. Herein, the phrase “coupled with” is defined to mean directly connected to or indirectly connected through one or more intermediate components. Such intermediate components may include both hardware and software based components. Each of the processors may be implemented in software, hardware, or a combination thereof and one or more of the processors may be integrated together or further subdivided into additional discrete components. The embodiments disclosed herein may be implemented in one or more computer programs executing on one or more programmable systems comprising at least one processor and at least one data storage system. Each such program may be implemented in any desired computer language to communicate with a computer system.

The mail server 102 includes one or more databases and/or servers that may receive court receipts from one or more courts. The mail server 102 may include any application operable to receive incoming emails, such as Microsoft Exchange™, Zimbra®, Sendmail®, POP3, or other email application. One or more email addresses may be configured on the mail server 102 for receiving court receipts from one or more courts. Upon receiving the court receipts, the mail server 102 may store the receipts in any manner within the constraints of the email application, e.g., chronologically, by sender, by subject, etc. The system 100 may track the court receipts in the mail server 102 that have been processed, or that have been retrieved by the retrieval processor 104, discussed below. For example, the system 100 may flag each court receipt that has been processed. The mail server 102 may identify to a user which court receipts have been processed, e.g., through the use of colors, highlighting, boldface or other visual identification.

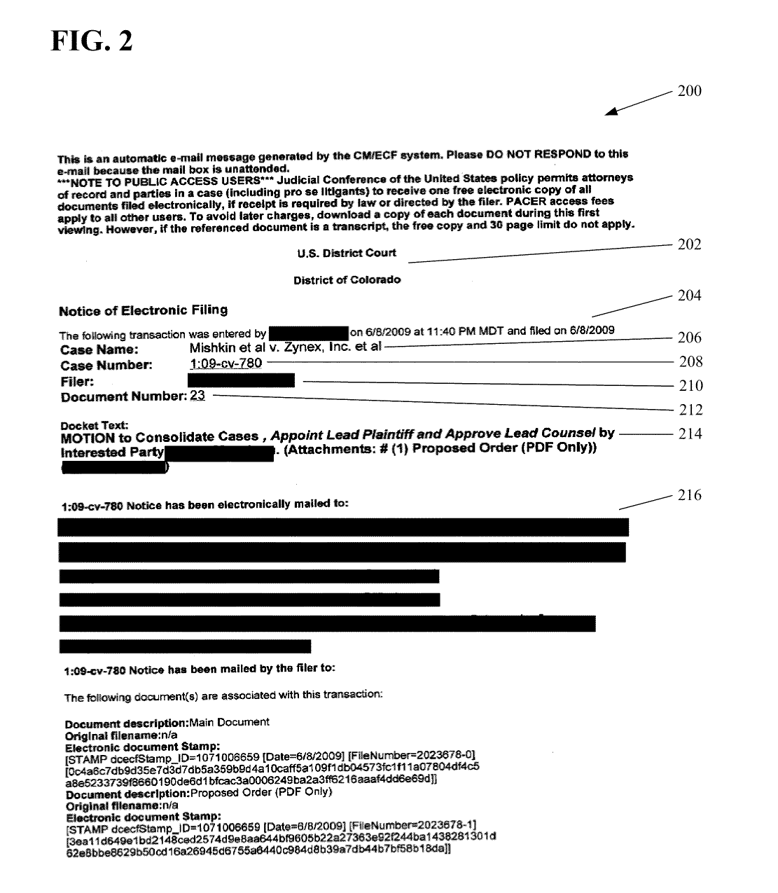

FIG. 2 shows an exemplary court receipt 200 that may be received by the mail server 102. As previously mentioned, the courts operate their own case management software, e.g., CM/ECF. In some cases, the courts may configure the software to conform to their local rules and practices. As a result, the court receipts received from different courts may differ in form or structure. However, often the differences are cosmetic only and do not alter the substance of the court receipt. As shown in FIG. 2, the court receipt 200 was generated by the United States District Court for the District of Colorado, designated at 202. The court receipt 200 includes the filing date 204, case name 206, case number 208, filer 210 (name redacted), document number 212, docket text 214 and notice of the registered participants that received a copy of the court receipt 200 (names redacted), designated at 216.

The retrieval processor 104 is coupled with the mail server 102 and retrieves court receipts from the mail server 102. The retrieval processor 104 may query the mail server 102 to determine if new court receipts are available, i.e., court receipts that have not been flagged as processed by the retrieval processor 104. The retrieval processor 104 may query the mail server 102 at any given interval of time, which may be user configurable. In one example, the retrieval processor 104 may query the mail server 102 every five minutes. The query intervals may be selected to continuously monitor the mail server 102 in time intervals that may not delay, bog down, or overload the operation of the system 100.

If the retrieval processor 104 does not locate any unprocessed court receipts on the mail server 102, it may loop back into a waiting position based on a timer, and at the selected time interval, it may send another query to the mail server 102. If the retrieval processor 104 locates one or more unprocessed court receipts, it may retrieve the court receipts and store the content of the court receipts on the docket database 106. The content may be stored as an HTML file, although other file types may used, e.g., text file. The retrieval processor 104 may also retrieve certain information and/or properties associated with the court receipts, collectively referred to as email properties, and store the email properties on the docket database 106. For example, the email properties may include the email subject, receipt date and sending address. The email properties may be stored on the docket database 106 as text data.

The retrieval processor 104 may generate and assign a unique identification code to each court receipt. The identification code may be used by the system 100 to track the court receipts. The retrieval processor 104 may store the copy of the court receipts, email properties associated with the court receipts, and the identification codes in a table, or other data structure, on the docket database 106. It will be appreciated that the retrieval processor 104 may store a copy of the court receipts as a backup to the mail server 102 in the event of failure or disruption to the mail server 102. When the retrieval processor 104 has completed processing the court receipts, the retrieval processor 104 may flag the court receipts on the mail server 102 to signify that the court receipts have been processed. The retrieval processor 104 may return to the query step, described above, after processing all of the new court receipts identified in the prior query.

It will be appreciated that by retrieving the court receipts from the mail server, the system 100 may maintain proper security measures as it analyzes and manipulates the court receipts. However, the processors and processes described herein may be capable of functioning directly on the court receipts received by and stored on the mail server 102.

The docket database 106 includes one or more databases and/or servers that store the court receipts and information related thereto that is retrieved by the retrieval processor 104. The docket database 106 may be integrated together in the same data storage system comprising the mail server 102, or divided into one or more data storage systems that may be distinct from or coupled with the mail server 102. The docket database 106 may store the court receipts, email properties and other information retrieved and/or generated by the retrieval processor 104 and the other processors described herein. The docket database 106 may also be coupled with a database and/or server utilized by a case management software or other docketing application such that the system 100 may access docket data managed by the software or application.

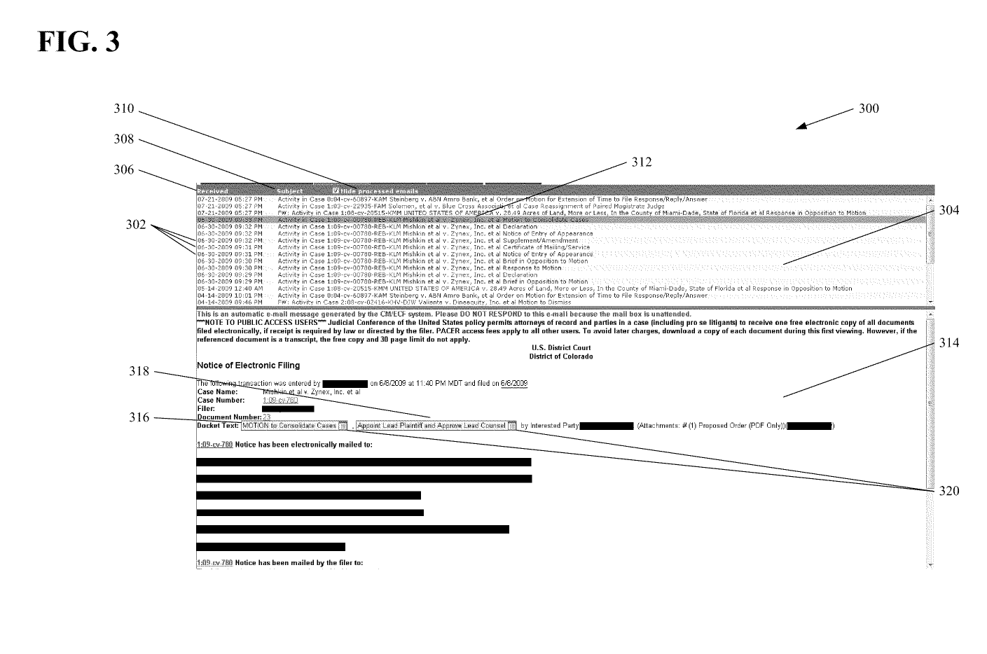

The content of the court receipts organized and stored on the docket database 106 may be displayed to a user within a browser. FIG. 3 shows an exemplary browser display 300 that may be generated based on a number of court receipts. In this example, the display 300 is organized similar to an email application. The court receipts 302 are shown in a receipts window 304. As shown, there are two columns in the receipts window 304 for organizing the court receipts, a “received” column 306 and a “subject” column 308. The information shown in the receipts window 304 under each of the columns may be pulled from the docket database 106. It will be appreciated that additional columns may be added, such as senders' address, or other email properties that may be retrieved from the court receipts. It will also be appreciated that the user may sort the court receipts 302 according to any of the columns There may also be a “hide processed” feature 310, which may hide all court receipts that have been docketed by the system 100. The processed/unprocessed court receipts may be visually distinguishable to a user, through the use of colors, highlighting, boldface or other visual identification.

A user may select a particular court receipt within the receipts window 304. The selected court receipt may be highlighted, as shown in the example at FIG. 3, designated by 312. The selected court receipt 312, in this example, corresponds to the exemplary court receipt shown in FIG. 2. When the user selects the court receipt, the HTML file corresponding to that court receipt is retrieved from the docket database 106 and displayed in the content window 314. As shown, the information in content window 314 corresponds to the information in court receipt 200, shown in FIG. 2.

The case assignment processor 108 is coupled with the docket database 106 and may assign a court receipt to a case. The case assignment processor 108 may parse through the content of the court receipt and scan for case identifying information. For example, the case assignment processor 108 may scan for certain word patterns, such as “case number”, “case name”, listed attorneys, etc., that may be used to identify a particular case. The case assignment processor 108 may retrieve the value or data that is associated with the identified word pattern. When the user selects a court receipt in the receipts window for docketing, the case assignment processor 108 may scan and retrieve the case identifying information. The case assignment processor 108 may scan the docket database 106 or other databases and/or servers where docket data is stored, to determine if the case number, or other case identifying information, matches an existing case number or information. If a match is located, the case assignment processor 108 may assign the court receipt to the case, thereby designating that the court receipt will be docketed in that case's docket. The case assignment processor 108 may create a link to the case number if a match is found, thereby giving a user the option to view the existing docket for that case. The case assignment processor 108 may assign a court receipt to a case automatically and without user input, which may increase efficiency and accuracy.

Alternatively, if the case assignment processor 108 is unable to match the court receipt to an existing case, e.g., the court receipt is the first receipt in a case, the user may be prompted to create a new case, or assign the court receipt to an existing case. If the user creates a new case, the user may be prompted to enter the client/matter number, registered attorneys in the case and/or other case information. The case assignment processor 108 may assign the new case to the court receipt, and any subsequent court receipts referencing that case. As a result, for new cases, a user may only be prompted one time to assign the initial court receipt to a new case, and all subsequent court receipts may be automatically assigned.

The user may also assign a court receipt to a preexisting case. The user may select a case from a list of existing cases stored on the docket database 106 or other databases and/or servers containing docket data. The case assignment processor 108 may assign the court receipt to the selected case. The case assignment processor 108 may also assign subsequent court receipts containing that case identifying information to the selected case. Additionally, in the event the case assignment processor 108 identifies multiple existing cases that match the case identifying information retrieved from a court receipt, the user may be prompted to select one of the existing cases. The case assignment processor 108 may utilize the selected case information to assign subsequent court receipts.

The case document processor 110 is coupled with the docket database 106 and may retrieve case documents from a document server, e.g., PACER, that are referenced in the court receipts. The case document processor 110 may query the docket database 106 for court receipts that reference case documents, which have not been retrieved. The case document processor 110 may query the docket database 106 at any given interval of time, e.g., five minutes, which may be user configurable. If an unprocessed court receipt is available, the case document processor 110 may scan the text of the court receipt and retrieve the document number and case number. The case document processor 110 may also obtain the case number from the case assignment processor 108.

The case assignment processor 110 may access a document server where the case documents are located. The case assignment processor 110 may be in communication with the document server through a network. Herein, a network refers to any communication method by which information may travel between computing devices, including, for example, one or more of a wireless network, a wired network, a local area network (LAN), a wide area network (WAN), a direct connection such as through a Universal Serial Bus (USB) port, and may include the set of interconnected networks that make up the Internet, intranet, or other communication network.

The case document processor 110 may programmatically enter login information to access the document server. The login information may be user configurable. The case document processor may also retrieve and activate a Uniform Resource Locator (“URL”) that may be located on the court receipt to access the document server. After accessing the document server, the case document processor 110 may automatically retrieve one or more case documents based on the case number and document number. In one example, the case document processor 110 may retrieve the browser cache files corresponding to the case documents. The case document processor 110 may store the retrieved case documents in PDF format, or other format, on the docket database 106 or another data storage device.

The case document processor 110 may also retrieve the document names from the online document server. The case document processor 110 may re-name the case documents with the corresponding document names. The case document processor 110 may flag or otherwise signify the court receipt in the docket database 106 after successfully retrieving and storing the case documents referenced in the court receipt. The case document processor 110 may logout from the online document server, and return to the query step, described above.

The docket processor 112 is coupled with the docket database 106 and may retrieve docket information from the court receipts to be used to generate docket entries and events. The docket processor 112 may retrieve information from the HTML file when the user selects or highlights the court receipt in the receipts window. For example, the docket processor 112 may parse through the court receipt content and scan for certain word patterns. In one example, the docket processor 112 scans for the pattern “filed on” and retrieves the filing date, or trigger date, that is located to the right of the word pattern. It will be appreciated that the docket processor 112 may scan the court receipt for any available information that may be used in the generation of docket entries and events, e.g., case name, case number, document number or other information.

The docket processor 112 may also scan for the word pattern “docket text.” There may be a number of filings, rulings, or activities within the “docket text” that may be individually docketed. The docket processor 112 may scan the docket text for certain keywords, e.g., motion, appoint, response, notice, etc., to parse out multiple docket entries. When the docket processor 112 identifies a keyword in the docket text, it may start a text box that highlights the docket text, and may end when the docket processor 112 identifies another keyword, or symbol. The docket processor 112 may automatically select multiple docket events contained in the court receipt.

In the example of FIG. 3, the docket processor 112 identifies the docket text “MOTION to Consolidate Cases” 316, and “Appoint Lead Plaintiff and Approve Lead Counsel” 318 as docket entries. As shown, the docket processor 112 created a text box over these portions of the docket text. The user may manipulate the text boxes on the content window 314 by selecting a start or stop edge of the text box and drag it to include or remove docket text. In this regard, the user may manually adjust the text boxes to ensure that the desired docket text is included in the text box. In another example, the user may toggle off the automatic text box feature, and manually create the text boxes, for example, by selecting and highlighting the desired docket text.

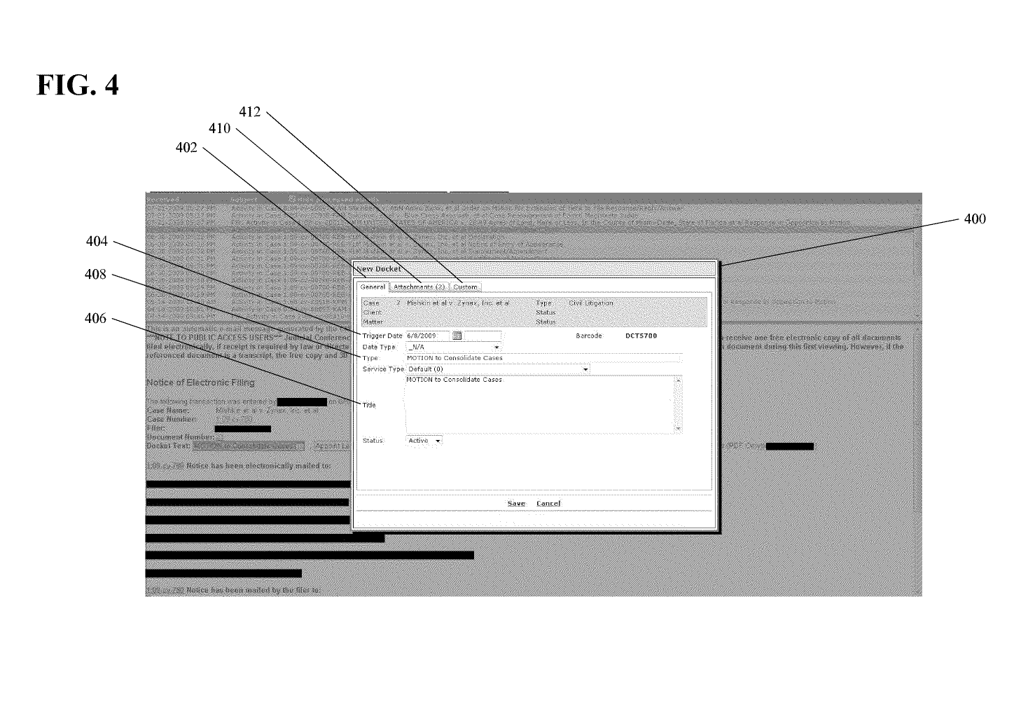

The docket processor 112 may insert a “create docket” icon 320 in proximity to the text boxes after the text boxes are generated. A user may select the icons 320 to create the docket entry. FIG. 4 shows an exemplary docket dialog box 400 that may be displayed when a user selects an icon. In this example, the docket dialog box 400 is displayed in response to the user selecting the icon corresponding to text box 316, shown in FIG. 3.

The docket dialog box 400, under the “General” tab 402, contains general information about the case to which the court receipt was assigned by the case assignment processor 108, including, for example, the case title, client and matter number, type of case, and case status. The docket dialog box 400 may also contain docket fields specific to the court receipt, which may be used in docketing the court receipt. For example, the docket dialog box may include a trigger date field 404, title field 406, and the pleadings type field 408, as shown in the example in FIG. 4. The docket processor 112 may automatically populate these fields with information it retrieves from the court receipt.

As shown in FIG. 4, the docket processor 112 populates the trigger date field 404 with the trigger date, i.e., Jun. 8, 2009 that the docket processor 112 retrieved from the exemplary court receipt shown in FIG. 3. Moreover, the docket processor 112 populates the title field 406 and the pleading type field 408 with the docket text, i.e., “MOTION to Consolidate Cases”, shown in FIG. 3. As described below, the pleading type field 408 is used to generate events based on applicable court rules. A user may toggle off the application of these court rules, in which case the pleading type field 408 may not be populated. Alternatively, the user may delete the information in the pleading type field 408 to ensure that the court rules are not applied to generate events for the court receipt.

The user may manually change the trigger date, title and pleading type within the docket dialog box 400. The user may also enter additional information in the docket dialog box 400, which may be used by the docket processor 112 to generate the docket entries and events. For example, the user may select the “Date Type”, which provides information regarding the trigger date. Examples of date types include appearance date, filed on date, received on date, and served on date. The user may also select the “Service Type”, which designates how the docket event was served, e.g., electronic, express mail, overnight delivery, etc. The service type may be used by the docket processor 112, in conjunction with the applicable court rules to generate events.

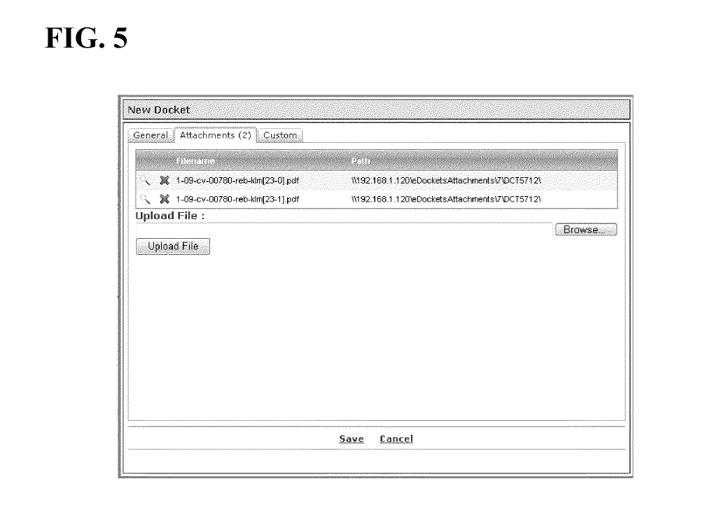

The docket dialog box 400 may also include an “Attachments” tab 410, which provides a link to the case documents retrieved by the case document processor 110. FIG. 5 shows the exemplary “Attachments” tab. As shown, there are two case documents that were referenced by the court receipt, and retrieved and stored by the case document processor 110. A link may be provided to the case documents to allow a user to view the case documents. In this regard, a user does not need to log onto a document server, such as PACER, which may incur a fee, or search through a network in order to view the case documents. The case documents are automatically retrieved and provided to the user. Moreover, the user may include additional documents to be associated with a court receipt by uploading additional files. Referring back to FIG. 4, the docket dialog box 400 may also include a “Custom” tab 412, which may log additional information regarding the docket entry and/or event entered by the user, such as comments to be displayed in conjunction with the docket entry and/or event.

If the application of the court rules has been toggled off, or if the pleadings type field 408 is empty, a user may create a docket entry, without an event, by selecting the “save” button on the docket dialog box 400. In response, the docket processor 112 may create a docket entry based on the title and trigger date. For example, docket processor 112 may output a text string comprising of the trigger date and followed by the title of the docket created. The docket processor 112 may also output additional information retrieved from the court receipt and/or entered by a user, e.g. through the “Custom” tab 412. The docket processor 112 may also output one or more URLs, links or locations corresponding to the case documents retrieved by the case document processor 110. In one example, the case documents may be stored on a network accessible by the docket processor 112 and/or users of the system. In this regard, if, for example, the docket entry is passed to an attorney via email, the case documents may be either attached to or linked within the email. The attorney therefore does not need to log on to an external server to locate the case documents, but can view them directly from the email alert containing the docket entry and event.

The court rules processor 114 is coupled with the docket processor 112 and the court rules database 116. The court rules database 116 includes one or more databases and/or servers that store court rules templates. The court rules database 116 may be integrated together in the same database storage system comprising the mail server 102 and/or docket database 106, or divided into one or more data storage systems that may be distinct from or coupled with the mail server 102 and/or docket database 106.

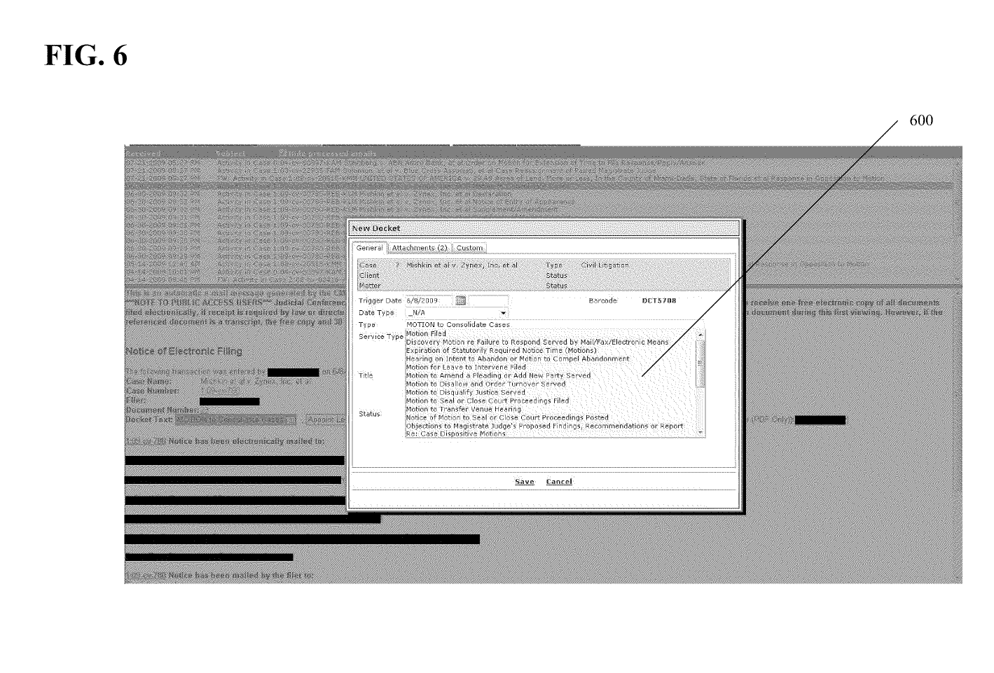

As mentioned, the docket processor 112 may populate the pleading type field 408 with docket text it retrieves from the court record. A user may select the pleading type and the court rules processor 114 may display a listing of all pleading types applicable to that court that relate to the pleading type included in the pleading type field 408. The listed pleading types may be comprised of local court rules, federal rules of civil procedure, or other applicable rules. For example, in FIG. 6, a user selected the pleading type 408 and the court rules processor generated a list of applicable pleading types 600 for the court that relate to pleading type 408. The user may select the desired pleading type from the list 600. The court rules processor 114 may generate the events based on the selected pleading type.

The court rules processor 114 may retrieve all the court rules templates from the court rules database 116 that apply to the selected pleading type and the court. The court rules processor 114 may assign the trigger date to the court rules templates. The court rules processor 114 may calculate the event deadlines for each of the templates based on the trigger date. The court rules processor 114 may recalculate the event deadlines based on an events hierarchy so that all child event deadlines may be properly calculated based on the parent event deadlines. Herein, a child event refers to an event that is dependent upon another event, i.e., the parent event. The court rules processor 114 may recalculate the event deadlines for events that may be associated with parent and/or child events. Herein, an associated event refers to an event that is associated with or dependent upon a parent and/or child event.

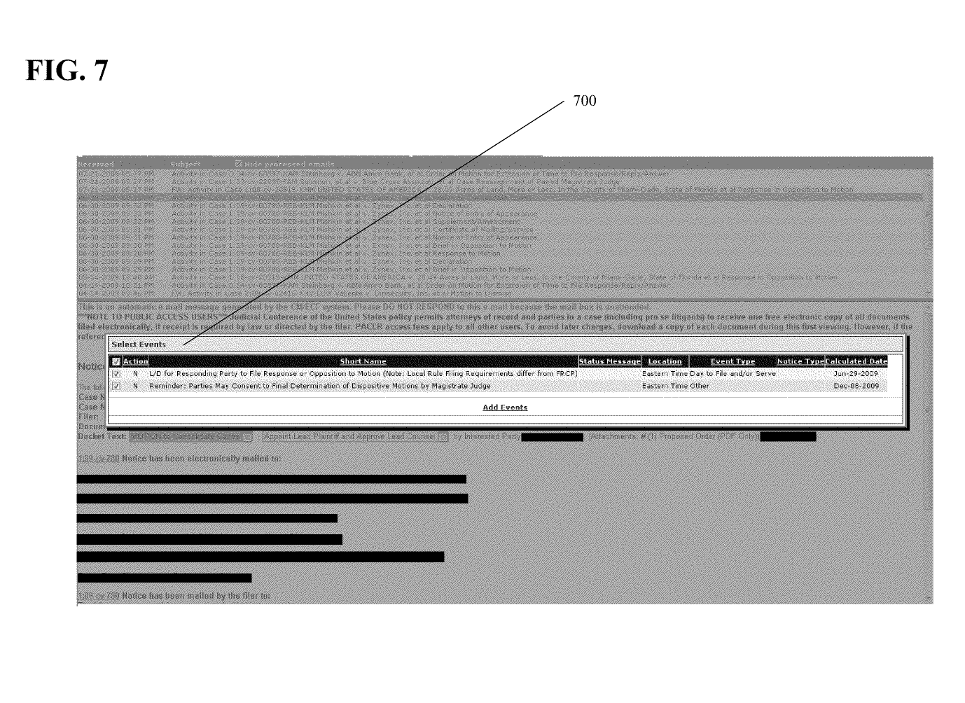

Based on the event deadlines calculated, the court rules processor 114 may output one or more events, including applicable deadlines and a description of the event. FIG. 7 shows an exemplary event dialog box 700 that may include the events generated by the court rules processor 114. The user may deselect any event so that it is not output by the system 100, or add events to be included with the docket entry.

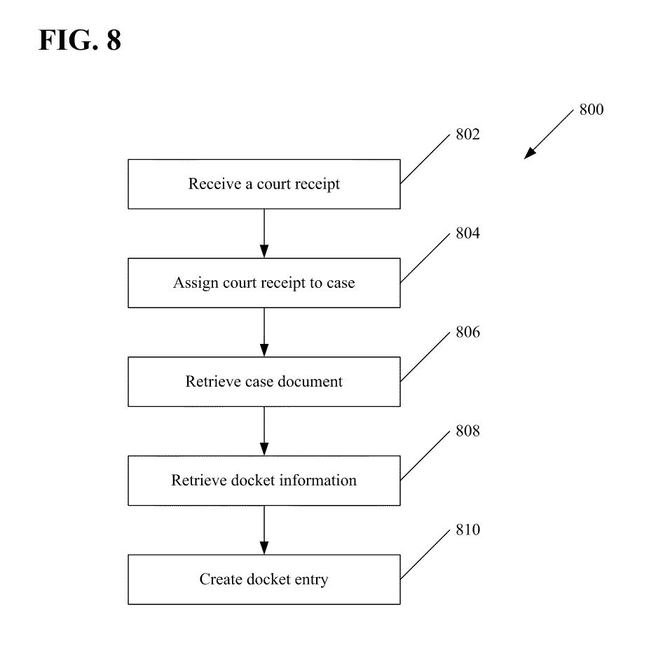

A flow diagram illustrating an exemplary process 800 according to one embodiment is shown in FIG. 8. The process 800 may be implemented for use with the system 100 of FIG. 1 or a different system. The process 800 begins with the receipt of a court receipt, represented by block 802. The court receipt may be received as an email from a court, and may be stored on a mail server or other database or server. The court receipt may contain docket information relevant for docketing the court receipt in a case docket. The process 800 proceeds to block 804 where the court receipt is assigned to a case. The court receipt may be automatically assigned to a case by retrieving a case number, or other case identifying information, located on the court receipt and matching the case number with an existing case number. If there is no match, or if multiple matches are found, a user may assign the court receipt to a case by creating a new case, or selecting an existing case.

The process 800 proceeds to block 806 where a case document that is referenced on the court receipt is retrieved from an online database and/or server. The case document may be downloaded, associated with the court receipt, and stored on an accessible database or server. The case document may also be renamed to correspond with the title or description of the document. The process 800 proceeds to block 808 where docket information is retrieved from the court receipt. The docket information may be retrieved by parsing the text of the court receipt for certain word patterns, and retrieving the values associated with the patterns. The process 800 proceeds to block 810 where docket entry is created. The docket entry may be created by populating docket fields with the retrieved docket information, and compiling the information to create the docket entry. The docket entry may be associated with one or more events derived from calculations based on the docket information and the applicable court rules in which the court receipt originated. The docket entry may also be associated with the case document automatically retrieved, such that a link may be provided to the location of the case document to enable viewing of the document. The docket entry and events may be input to a case management software or other docketing application to generate and/or update a docket.

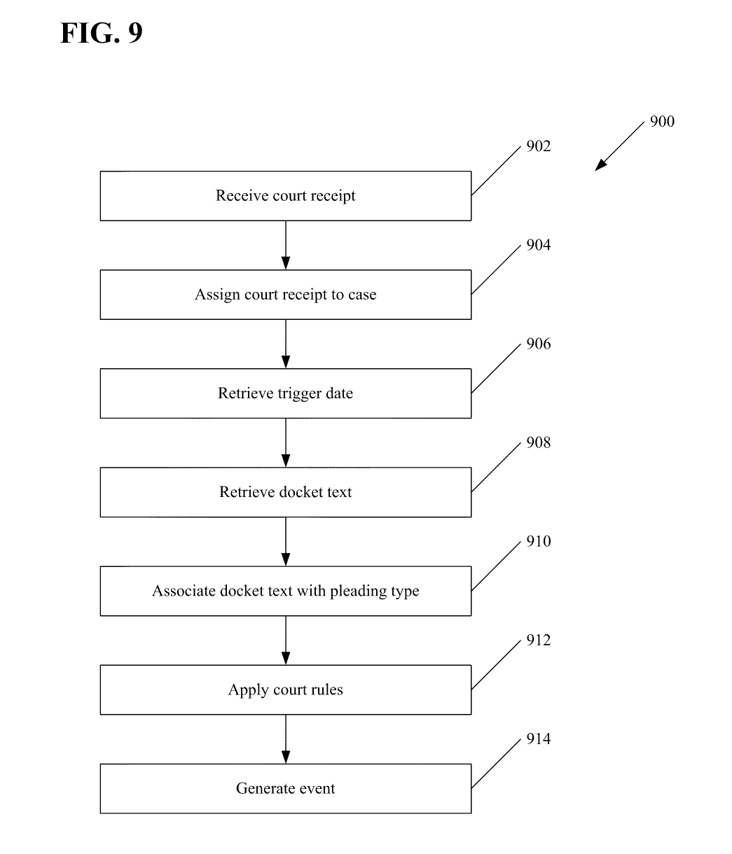

A flow diagram illustrating an exemplary process 900 according to one embodiment is shown in FIG. 9. The process 900 may be implemented for use with the system 100 of FIG. 1 or a different system. The process 900 begins with the receipt of a court receipt, as explained herein, represented by block 902. The court receipt may contain docket information that may trigger one or more events. The process 900 proceeds to block 904 where the court receipt is assigned to a case, as explained herein. The process 900 proceeds to block 906 where the trigger date is retrieved from the court receipt. The trigger date may be retrieved by parsing the text of the court receipt for certain word patterns, such as “filed on”, and retrieving the value to the right of the word pattern. The process 900 proceeds to block 908 where the docket text is retrieved. The docket text may be retrieved by parsing the text of the court receipt for certain word patterns, such as “docket text”, and then parsing the text thereafter for certain keywords and or symbols.

The process 900 proceeds to block 910 where the retrieved docket text is associated with a pleading type. The pleading type may correspond to a pleading type available within the applicable court rules in which the court receipt originated. The process 900 proceeds to block 912 where the court rules are applied. The court rules may be applied by selecting court rule templates based on the pleading type. The trigger date may be applied to the selected templates, and event deadlines, including child and events associated with child and/or parent events, are calculated based on the templates and trigger date. The process 900 proceeds to block 914 where the event is generated. The event may be generated by compiling the action required, or event name, with the calculated deadline or deadlines. The event may be input to a case management software or other docketing application to generate and/or update a docket.

It will appreciated that the system 100 may increase efficiency and timeliness of maintaining and updating dockets, and may decrease costs by eliminating the need for large docketing staff. The system 100 may also increase accuracy by, for example, eliminating typographical errors and other human errors that may otherwise occur. The increased accuracy may result in reduced liability and malpractice claims that may result from inaccurate dockets. The system 100 may output docket entries and events based on court receipts. The system may input the docket entries and events into a case management software or other docketing application, which may use the docket entries and events to generate and/or update dockets. The system 100 may be programmed into, or operate in connection with a case management software or other docket application. The system 100 may also be programmed into, or operate in connection with an email application, such as Microsoft Exchange™, POP3, or other email application.

It will be appreciated that the system 100 may be used in connection with any time-sensitive matter that may require docketing and where an administrative body sends receipts and/or notifications in response to electronic filings or other activities or events that occur in the matter. For example, the system may be used in connection with patent and trademark prosecution matters in the Patent and Trademark Office (“PTO”), matters before the Board of Patent Appeals and Interferences and Trademark Trial and Appeal Board, copyright prosecution in the United States Copyright Office, patent and trademark matters in the World Intellectual Property Office, mediation disputes such as domain name disputes, etc.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method of docketing a court receipt comprising:
receiving a court receipt from a court;
associating the court receipt with a case;
retrieving docket information from the court receipt; and
creating a docket entry for the case based on the docket information.

2. The method of claim 1 wherein the associating comprises:
retrieving case identifying information from the court receipt; and
matching the case identifying information with an existing case stored on a database.

3. The method of claim 2 wherein if the case identifying information does not match an existing case; the associating further comprising:
receiving a new or existing case; and
associating the court receipt with the new case.

4. The method of claim 1 wherein the retrieving comprises retrieving at least one of a case number, trigger date, and docket text.

5. The method of claim 1 wherein the retrieving comprises:
identifying one or more docketable entries from retrieved docket text.

6. The method of claim 1 further comprising:
retrieving a case document associating with the court receipt.

7. The method of claim 6 wherein the retrieving comprises:
locating a document number and a case number on the court receipt;
accessing a document server; and
retrieving the case document from the document server based on the document number and case number.

8. The method of claim 1 further comprising:
applying court rules to the docket information; and
generating one or more events based on the applying.

9. The method of claim 8 wherein the applying comprises:
calculating event deadlines by applying a retrieved trigger date to one or more court rule templates selected based on a received pleading type.

10. A system for docketing a court receipt comprising:
a mail server operable to receive a plurality of court receipts from one or more courts to be stored on a database;
a case assignment processor coupled with the database and operable to assign the plurality of court receipts to a case;
a docket processor coupled with the database and operable to create docket entries based on information retrieved from the plurality of court receipts and the case assignment.

11. The system of claim 10 wherein the mail server comprises an electronic mail server operable to receive electronic mail.

12. The system of claim 10 wherein the information comprises at least one of a case number, trigger date, and docket text.

13. The system of claim 10 further comprising:
a retrieval processor coupled with the mail server and operable to retrieve the court receipts from the mail server and store the court receipts on the database.

14. The system of claim 10 further comprising:
a case document processor coupled with the database and operable to retrieve one or more case documents from a document server based on information retrieved from the court receipts.

15. The system of claim 15 wherein the case document processor retrieves a document name corresponding to the one or more case documents and names the case documents accordingly.

16. The system of claim 10 further comprising:
a court rules processor coupled with the docket processor and operable to apply court rules to information retrieved from the court receipts.

17. A system for docketing a court receipt comprising:
assigning means for assigning a court receipt received from a court to a case docket;
retrieving means for retrieving docket information from the court receipt; and
generating means for generating a docket entry as a function of the assigning means and retrieving means.

18. The system of claim 17 wherein the docket information comprises at least one of a case number, trigger date, and docket text.

19. The system of claim 17 further comprising:
retrieving means for retrieving one or more case documents referenced by the court receipt.

20. The system of claim 17 further comprising:
applying means for applying court rules to the docket information to generate one or more events.
